(19) United States
(12) Patent Application Publication
(10) Pub. No.: US 2017/0059013 A1
(43) Pub. Date: Mar. 2, 2017

(54) PULLEY DEVICE WITH RETAINING PLUG

(71) Applicants: Daniel Capoldi, St Cyr-sur-Loire (FR); Frederic Bordier, Neuille Pont Pierre (FR); Laurent Cherioux, Tours (FR)

(72) Inventors: Daniel Capoldi, St Cyr-sur-Loire (FR); Frederic Bordier, Neuille Pont Pierre (FR); Laurent Cherioux, Tours (FR)

(73) Assignee: Aktiebolaget SKF, Goteborg (SE)

(21) Appl. No.: 15/244,611

(22) Filed: Aug. 23, 2016

(30) Foreign Application Priority Data
Aug. 26, 2015 (EP) 15306316.9

(51) Int. Cl. F16H 7/12; F16C 35/063

(52) U.S. Cl. CPC F16H 7/12; F16C 35/063; F16C 2361/63; F16H 2007/0865

(57) ABSTRACT

A pulley device that includes a bearing, a pulley mounted on the bearing and two shields disposed axially on either side of the bearing is provided. The device further includes one retaining plug mounted into a bore of the bearing and a bore of each shield. The retaining plug is fitted at least in the bore of the bearing and cooperates by contact with the shields to retain the shields on the plug.

### CROSS-REFERENCE TO RELATED APPLICATIONS

This application claims priority to European patent application no. EP15306316.9 filed on Aug. 26, 2015, the contents of which are fully incorporated herein by reference.

### FIELD OF THE INVENTION

The present invention relates to the field of pulley devices for tensioning idlers or runner rollers or automatic tensioners designed to interact with a chain or a belt, for example a distribution belt of an internal combustion engine of a vehicle.

### BACKGROUND OF THE INVENTION

Such rollers are usually used to keep a constant tension on the belt or the chain in a determined range or to locally modify the path taken by the latter. These are called respectively tensioning idlers or runner rollers. In runner rollers, the pulley is mounted so as to rotate on a screw or a spindle by means of a rolling bearing, the roller then being attached directly or indirectly to the engine block or to an element of a tensioning idler device, for example an articulated arm or an eccentric.

A pulley device is supplied to a car manufacturer with its screw and often with sealing shields to protect the device against the intrusion of foreign particles from the outside environment. The pulley device generally provides a friction ring cooperating with the screw to form a unitary assembly for transport.

However, for the vehicle service market segment which supplies aftermarket parts for cars, the pulley device is not delivered with a screw. Such a pulley device is not supplied as a unitary assembly.

### BRIEF SUMMARY OF THE INVENTION

One aim of the present invention is to overcome this drawback.

It is a particular object of the present invention to provide a unitary pulley device for vehicle service market segment.

In one embodiment, the pulley device for belt or chain tensioning idler or runner roller comprises a bearing, a pulley mounted on the bearing and two shields disposed axially on either side of the bearing. The device further provides one retaining plug mounted into a bore of the bearing and a bore of each shield. The retaining plug is fitted at least in the bore of the rolling bearing. The retaining plug cooperates by contact with the shields to retain the shields on the plug.

The pulley device constitutes a unitary assembly that can be handled and transported. A single element enables to achieve a dual function, namely to support the bearing as well as the two shields, and to retain the shields relative to the bearing. The axial retention of the plug with respect to the bearing is obtained by fitting. An interference fit may be provided.

The shields may be mounted in axial contact with the bearing.

Preferably, the retaining plug provides first and second retaining means each cooperating with one of the shields. The first retaining means may axially bear against the associated shield axially on the side opposite to the bearing to axially retain the shield by axial pinching. The second retaining means may radially come into contact with the bore of the associated shield to axially retain the shield by radial wedging.

In one embodiment, the retaining plug is provided with a first large-diameter portion comprising the first retaining means and with a second large-diameter portion comprising the second retaining means. The second large-diameter portion may extend from the first large-diameter portion.

In one embodiment, the first retaining means of the plug provide a plurality of ribs protruding radially outwards and spaced apart one with another in the circumferential direction. The second retaining means may provide a plurality of ribs protruding radially outwards and spaced apart one with another in the circumferential direction.

Preferably, the retaining plug provides error prevention means for proper installation of the device on an associated engine. The error prevention means may be marked on the retaining plug and/or provided on a flange of the plug.

Advantageously, the retaining plug is made in one part. The plug may be made from plastic material.

In one embodiment, the bearing provides an inner ring, an outer ring and at least one row of rolling elements disposed into a radial space existing between the rings, the shields being located outside from the radial space.

### BRIEF DESCRIPTION OF THE SEVERAL VIEWS OF THE DRAWING

The present invention and its advantages will be better understood by studying the detailed description of a specific embodiment given by way of non-limiting example and illustrated by the appended drawings on which:

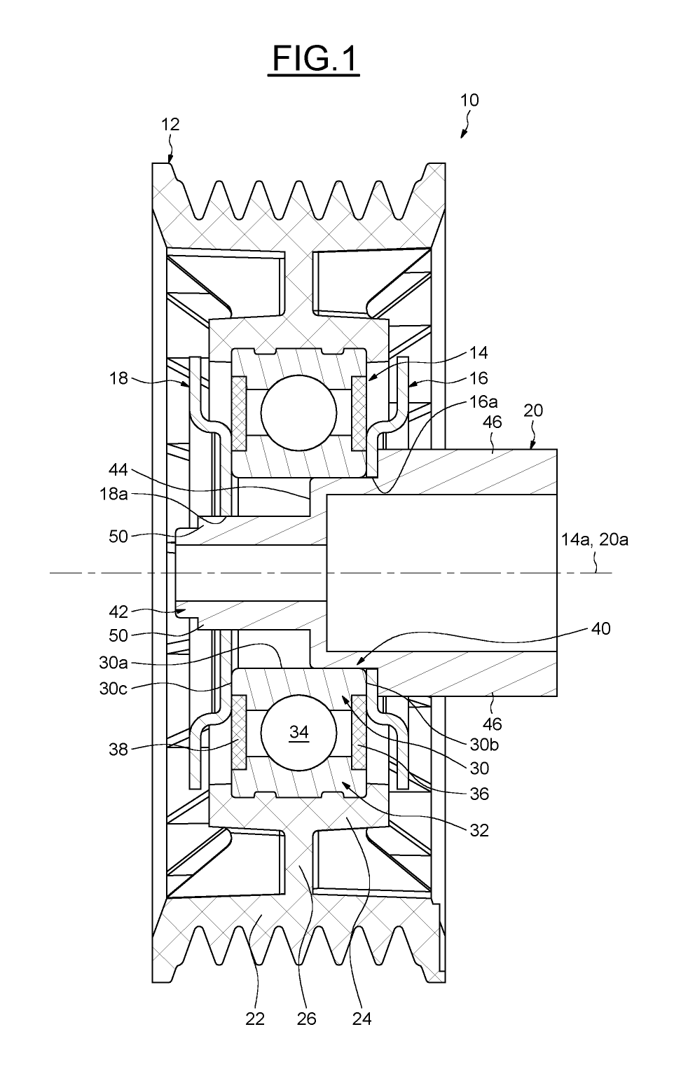

a. FIG. 1 is a cross-section of a pulley device according to an example of the invention, and

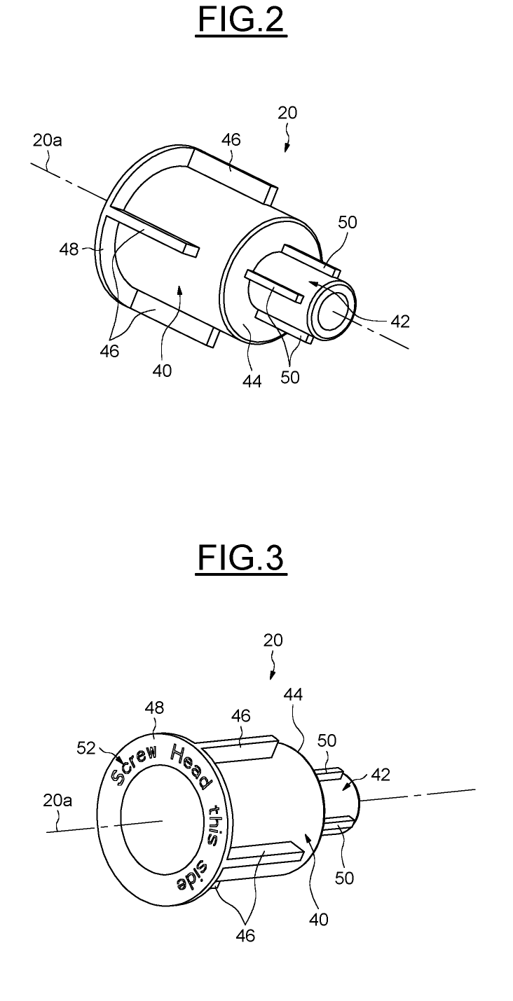

b. FIGS. 2 and 3 are exploded perspective views of a retaining plug of the device of FIG. 1.

### DETAILED DESCRIPTION OF THE INVENTION

As shown on FIG. 1, a pulley device 10 provides a pulley 12 adapted to interact with a belt or a chain (not shown), a rolling bearing 14 supporting the pulley, with a geometric axis 14a, and first and second sealing end-plates or shields 16, 18 disposed axially on either side of the rolling bearing. As will be described later, the device 10 further provides on single retaining plug 20 onto which are mounted the rolling bearing 14 and the shields 16, 18 and adapted to axially retain on the plug each of the shields relative to the bearing.

The pulley 12 provides an axial annular outer portion 22 providing an outer surface designed to interact with a belt or a chain, an axial annular inner portion 24, and a radial annular intermediate portion 26 connecting the outer and inner portions. The portions 22, 24 are concentric and coaxial with the axis 14a. Ribs (not referenced) are also provided between the outer and inner portions 22, 26.

The rolling bearing 14 provides an inner ring 30, an outer ring 32 onto which is mounted the pulley 12, and a row of rolling elements 34, which in this case are balls, radially disposed between the rings. The rolling bearing 14 further provides on each side an annular seal 36, 38 to close the radial space that exists between the rings 30, 32 and inside which are located the rolling elements 34. The seals 36, 38 are mounted radially between the inner and outer rings 30, 32. The seals are illustrated schematically on FIG. 1.

The inner ring 30 provides an outer cylindrical surface (not referenced) onto which is formed a toroidal circular raceway for the rolling elements 34. The inner ring 30 also provides a cylindrical bore 30a and two radial surfaces 30b, 30c which axially delimit the bore and the outer surface. The bore 30a forms the bore of the rolling bearing. The inner ring 32 has a similar design. In the illustrated example, the inner and outer rings 30, 32 are of the solid type. In the illustrated example, the pulley 12 is obtained by overmoulding a plastic material, such as a polyamide, on the outer ring 32. This leads to an excellent cohesion between these parts. Alternatively, the pulley 12 may be glued onto the outer ring 12 or be made of metal sheet and fitted onto the ring. In another variant, the pulley 12 and the outer ring 12 may be formed in one part.

Each sealing shield 16, 18 is made in one part and may be advantageously manufactured in an economic way by cutting, stamping and folding a metal sheet. Alternatively, the shields 16, 18 may be formed from another metallic material such as copper or aluminum or from an alloy such as brass. Alternatively, the shields 16, 18 may be made from synthetic material like polyamide.

Each shield 16, 18 is arranged laterally to the rolling bearing 14. Each shield 16, 18 is located outside from the radial space that exists between the inner and outer rings 30, 32. Each shield 16, 18 is located outside from the bore 30a of the rolling bearing. Each shield 16, 18 is mounted axially into contact against the inner ring 30. The shield 16 axially bears against the radial surface 30b of the inner ring while the shield 18 axially comes into contact with the opposite radial surface 30c of the ring. Each shield 16, 18 has an annular cup form. Each shield 16, 18 has a cylindrical bore 16a, 18a coaxial with the axis 14a of the rolling bearing. In the illustrated example, the diameter of the bore 16a is larger than the one of the bore 18a.

Each shield 16, 18 extends radially outwards. In the illustrated example, each shield 16, 18 extends radially towards the pulley 12 to define with the pulley a labyrinth passage in order to reduce the intrusion of contaminants. The outer free edge of each shield 16, 18 defines with the inner portion 24 of the pulley the labyrinth passage. Alternatively, each shield 16, 18 may extend radially towards the outer ring 32 to define with the ring the labyrinth passage.

The retaining plug 20 is distinct from the sealing shields 16, 18. The retaining plug 20 is made in one part. The plug 20 may be made from synthetic material by molding. The plug 20 extends along an axis 20a which is coaxial with the axis 14a of the rolling bearing. In the illustrate example, the plug 20 is provided with an axial through-hole (not referenced). Accordingly, a weight reduction is obtained. Alternatively, the plug 20 may be deprived of such hole.

The plug 20 is mounted into the bore 30a of the rolling bearing and into the bore 16a, 18a of each shield. The plug 20 supports the rolling bearing 14 and the shields 16, 18. The plug 20 is fitted into the bore 30a of the rolling bearing. The plug 20 is centred in the bore 30a and the bores 16a, 18a of the shields. The plug 20 is not permanently secured to the rolling bearing 14 and the shields 16, 18. As will be described later, the plug 20 may be removed by an operator from the rolling bearing 14 and the shields 16, 18.

As shown more clearly on FIGS. 2 and 3, the plug 20 provides a first cylindrical portion 40 having a large diameter and a second cylindrical portion 42 having a small diameter extending form the first portion. An annular radial shoulder 44 is delimited between the first and second portions 40, 42.

The plug 20 also provides a first group of radial ribs 46 formed on the outer surface of the first portion 40. The ribs 46 extend axially along the outer surface. The ribs 46 leave entirely free a part of the outer surface of the first portion 40 axially located on the side of the second portion 42. The ribs 46 protrude radially outwards. The ribs 46 are spaced apart with one another in the circumferential direction. In the illustrated example, an annular flange 48 is formed on the outer surface of the first portion 40 at an end of the portion which is axially opposite to the second portion 42. The ribs 46 extend axially from the flange 48.

The plug 20 further provides a second group of radial ribs 50 formed on the outer surface of the second portion 42. The ribs 50 extend axially along the outer surface. The ribs 50 protrude radially outwards. The ribs 50 are spaced apart with one another in the circumferential direction. In the illustrated example, the ribs 50 extend from the radial shoulder 44.

Referring once again to FIG. 1, the first portion 40 of the plug is mounted into the bore 30a of the rolling bearing and into the bore 16a of the first shield while the second portion 42 is mounted into the bore 30a and into the bore 18a of the second shield.

The rolling bearing 14 and the first shield 16 are mounted on the first portion 40 of the plug. The bore 30a of the bearing is mounted in radial contact with the outer surface of the first portion 40. A small radial gap is here provided between the bore 16a of the first shield and the outer surface. The ribs 46 of the plug axially bear on the first shield 16 on the side opposite to the rolling bearing 14. The ribs 46 come into contact with the outer surface of the shield 16. The shield 16 is axially disposed between the ribs 46 and the inner ring 30 of the rolling bearing. The shield 16 is in axial contact against the inner ring 30 on one side and in axial contact with the ribs 46 on the other side. The shield 16 is blocked by axial pinching between the ribs 46 and the rolling bearing 14. The ribs 46 form retaining means of the shield 16 on the plug 20.

The second shield 18 is mounted on the second portion 42 of the plug. The bore 18a of the second shield is mounted in radial contact with the ribs 50. The ribs 50 radially come into contact with the bore 18a of the second shield. The shield 18 is axially maintained on the plug 20 by radial wedging. The shield 18 is fitted on the ribs 50. The ribs 50 form retaining means of the shield 18 on the plug 20.

Referring once again to FIG. 3, the plug 20 provides error prevention means 52 for proper installation of the device 10 on an associated engine (not shown). These means 52 are marked on the flange 48 of the plug axially on the side opposite to the second portion 42. These means 52 provides the indication “Head Screw this side” in order that the operator may easily determine how to mount the pulley device 10 relative to the engine. To this end, the operator firstly removes the retaining plug 20 from the rolling bearing 14 and the shields 16, 18 while maintaining the bearing and shields. Then, the operator manually mounts a screw (not shown) inside the bores of the rolling bearing 14 and the shields 16, 18. Finally, the screw is tightened for fixing the pulley device 10 on the engine.

In the disclosed example, the first retaining means of the plug provide a plurality of radial ribs 46 axially bearing against the first shield 16. Alternatively, the ribs 46 may be replaced by an annular flange formed on the outer surface of the plug. In another variant, it could be possible to achieve the axial retention of the shield 16 on the plug 20 by radial wedging. In the illustrated example, the second retaining means of the plug provide a plurality of radial ribs 50 radially bearing against the shield 18. Alternatively, the ribs 50 may be replaced by an annular portion radially coming into contact with the bore of the shield 18. However, with a plurality of spaced ribs, a weight reduction for the plug 20 is obtained.

The invention has been illustrated on the basis of a pulley device comprising a rolling bearing provided with at least one row of rolling elements radially disposed between the inner and outer rings. Alternatively, the bearing may be a sliding bearing comprising one or two rings.

1. A pulley device for a belt or chain tensioning idler or runner roller or automatic tensioner comprising:
a bearing,
a pulley mounted on the bearing,
two shields disposed axially on either side of the bearing, and
a retaining plug mounted into a bore of the bearing and a bore of each shield, the retaining plug being fitted at least in the bore of the bearing and cooperating by contact with the shields to retain the shields on the plug.

2. The device according to claim 1, wherein the shields are mounted in axial contact with the bearing.

3. The device according to claim 1, wherein the retaining plug comprises first and second retaining means each cooperating with one of the shields.

4. The device according to claim 3, wherein the first retaining means of the plug axially bear against the associated shield on the side opposite to the bearing to axially retain the shield by axial pinching.

5. The device according to claim 3, wherein the second retaining means of the plug radially come into contact with the bore of the associated shield to axially retain the shield by radial wedging.

6. The device according to claim 3, wherein the retaining plug is provided with a first large-diameter portion comprising the first retaining means, and with a second large-diameter portion comprising the second retaining means.

7. The device according to claim 6, wherein the second large-diameter portion extends from the first large-diameter portion.

8. The device according to claim 3, wherein the first retaining means of the plug comprises a plurality of ribs protruding radially outwards and spaced apart one with another in the circumferential direction.

9. The device according to claim 3, wherein the second retaining means of the plug comprises a plurality of ribs protruding radially outwards and spaced apart one with another in the circumferential direction.

10. The device according to claim 1, wherein the retaining plug comprises error prevention means for proper installation of the device on an associated engine.

11. The device according to claim 10, wherein the error prevention means are marked on the retaining plug.

12. The device according to claim 10, wherein the retaining plug comprises a flange provided with the error prevention means.

13. The device according to claim 1, wherein the retaining plug is made in one part.

14. The device according to claim 1, wherein the retaining plug is made from plastic material.

15. The device according to claim 1, wherein the bearing comprises an inner ring, an outer ring and at least one row of rolling elements disposed into a radial space existing between the rings, the shields being located outside from the radial space.
